(19) United States
(12) Patent Application Publication
(10) Pub. No.: US 2022/0235189 A1
(43) Pub. Date: Jul. 28, 2022

(54) EXTRACTION METHOD

(71) Applicant: FUTAMURA CHEMICAL UK LTD., Cumbria (GB)

(72) Inventors: Martin COCKROFT, Cumbria (GB); Luke FISHER, Cumbria (GB)

(21) Appl. No.: 17/596,600

(22) PCT Filed: Jul. 3, 2020
(86) PCT No.: PCT/EP2020/068890

§ 371 Date: Dec. 14, 2021

(30) Foreign Application Priority Data
Jul. 3, 2019 (GB) 1909583.5
Dec. 24, 2019 (GB) 1919267.3

(51) Int. Cl. C08J 5/18; C08B 1/08; C08L 1/02; C08B 1/00; B65D 65/46

(52) U.S. Cl. CPC C08J 5/18; C08B 1/08; C08J 2301/02; C08B 1/003; B65D 65/466; C08L 1/02

(57) ABSTRACT

The present invention provides a method for extracting a solid purified product from an alkaline polysaccharide-containing precursor material, comprising the steps of:
(a) neutralising the alkaline polysaccharide-containing precursor material with an acid and obtaining a neutralised solid polysaccharide-containing material;
(b) mixing the neutralised solid polysaccharide-containing material with bleach to create a mixture; and
(c) separating a solid purified product from the mixture.

This application is a national stage application of International Patent Application No. PCT/EP2020/068890, filed Jul. 3, 2020, which claims priority to Great Britain patent Application Nos. 1909583.5, filed Jul. 3, 2019, and 1919267.3, filed Dec. 24, 2019. The entirety of the aforementioned applications is incorporated herein by reference.

### FIELD

The present invention provides a method for extracting a solid purified product from an alkaline polysaccharide-containing precursor material. In particular, though not exclusively, the solid product comprises cellulose.

### BACKGROUND

Plastics and non-biodegradable materials are at the forefront of the world's packaging pollution problems. Polysaccharide materials, and in particular cellulosic materials, such as films can be used to make a range of packaging materials that are compostable and biodegradable. However, the extraction of such polysaccharides from polysaccharide-containing materials can be laborious and expensive, particularly when agricultural waste such as oat hulls, tomato leaves and rice husks are used. Additionally, the polysaccharide solutions resulting from many known processes are not stable over time and so are not easy to introduce into a commercial production line for creating such packaging.

Currently, agricultural waste is sold for very little money, sometimes even at a loss, and is often burnt, dug back into the ground or mixed in with animal feed. Therefore, there is a current demand to make use of these waste materials. The UK alone produces a huge amount of agricultural waste a year. For example, one 50-acre site generates around 4 tonnes of tomato leaves as waste per day, which contains 150 to 200 kg of usable cellulose. Thus, reducing a portion of the material wasted by accessing this usable cellulose would be hugely beneficial to the environment, the producer and the consumer. A UK supermarket could save around 3.5 million plastic trays a year if they changed to a tray produced from agricultural waste.

Certain methods have been considered for the extraction of a purified polysaccharide product from sources such as agricultural waste materials.

For example, WO0214598 describes a multifunction process for the separation of cellulose from other constituents of lignocellulosic biomass using steam.

CN102733219 describes a chemical extraction method of agricultural waste, particularly a method for extracting cellulose from tobacco waste based on a redox agent. The process removes hemicellulose, lignin, soluble matter and cellulose crystallinity from the tobacco raw material using the redox agent method.

WO2012/021056 describes a method for producing microcrystalline cellulose from biomass waste. Specifically, the disclosed method employs a chlorination pre-treatment process to convert the biomass waste into α-cellulose, to facilitate the production of crystallites.

CN105648120 describes a method for preparing xylose functional sugar from hemicellulose polysaccharide in agricultural waste.

CN105669879 describes a preparation method of xylooligosaccharide, which extracts xylan from agricultural fibre waste containing hemicellulose using an alkali method.

CN108557802 describes a method for preparing a cellulose carbon aerogel using agricultural waste.

Hu et al. [2017] EXTRACTION AND CHARACTERIZATION OF CELLULOSE FROM AGRICULTURAL WASTE ARGAN PRESS CAKE. Cellulose Chem. Technol. 51 p263-272 describes an effective extraction method of cellulose with high purity from agricultural waste APC, using a bleaching sequence.

Such solid purified polysaccharide products are often then dissolved in an alkaline solution, such as sodium hydroxide, for further processing. However, as discussed in T. Budtova and P. Navard, “Cellulose in NaOH-water based solvents: a review” Cellulose, 2016, 23(1), pp. 5-55, creating these solutions involves various difficulties, including low solubility and subsequent gelling of the solution. The formation of a gel can be reduced by reducing the concentration of cellulose in the solution, reducing the temperature or including additives.

### DETAILED DESCRIPTION

The aim of the present invention is to provide an improved method of extracting a solid purified product from a polysaccharide-containing material that is environmentally friendly, efficient and cost-effective, as well as providing a polysaccharide solution with improved gel stability, particularly when said solution comprises the polysaccharide dissolved in an alkali solution such as sodium hydroxide.

According to a first aspect of the present invention, there is provided a method for extracting a solid purified product from an alkaline polysaccharide-containing precursor material, comprising the steps of:
(a) neutralising the alkaline polysaccharide-containing precursor material with an acid and obtaining a neutralised solid polysaccharide-containing material;
(b) mixing the neutralised solid polysaccharide-containing material with bleach to create a mixture; and
(c) separating a solid purified product from the mixture.

The term “solid purified product” is intended to mean that the product is purified compared to the alkaline polysaccharide-containing precursor material. An increased purity can be identified by an increased decolourisation. This could be measured by determining the brightness (using the method outlined in TAPPI T452) or LAV number (using the method outlined in TAPPI T562) of a paper produced therefrom.

Thus, a number of components present in the alkaline polysaccharide-containing precursor material are removed and are not present in the solid purified product. However, it is not intended to mean that the solid purified product contains a single component, as some additional components may still be present. The term “solid product” may therefore alternatively be used.

The method of the present invention extracts a purified product from a precursor material. Thus, the method may be considered a method of purifying a material or a method for obtaining a purified material.

The inventors of the present invention have surprisingly found that the sequential steps of the above-mentioned method provide an effective method for extracting a solid purified product, which is superior to conventional methods in the art. This is because the process of the present invention is cost-effective, easily scalable and has mild process conditions, which do not require the use of expensive and environmentally damaging compositions.

For example, the method according to the present invention does not require the use of carbon disulphide and so the method according to the present invention operates with less extreme conditions and is more environmentally friendly than conventional methods.

The product created by the method of the present invention is purer than many of those created using methods of the prior art. Additionally, the product is more stable, particularly when combined with an alkali to form a polysaccharide solution, particularly a cellulose solution. Such a polysaccharide solution has a greatly improved gel stability.

Direct dissolution of wood pulp in sodium hydroxide is known to result in gel formation in less than 24 hours, often less than 8 hours. The direct dissolution of the product of the present invention in sodium hydroxide does not result in gel formation at 24 hours and has found to have no gel formation after a week, preferably after 2 weeks and more preferably after a month, at room temperature.

The formation of a gel can be measured by eye, or by tracking the elastic modulus G′ and viscous modulus G″, with the point at which the value of G′ meets G″ being the gelation point.

The alkaline polysaccharide-containing precursor material may be derived from agricultural waste selected from oat hulls, tomato leaves, rice husks, jute, straw, wheat, miscanthus, hemp, grass, flax or food crop waste. Agricultural waste herein refers to plant-based agricultural waste.

Other suitable agricultural waste sources may include coconut fibre, tea shell, chaff fibres, Phoenix dactylifera, Borassus flabellifer, leaf stalks or ginger.

Such materials are widely available and are considered waste materials. Thus, they are cheap and their recycling in the current process means that alternative disposal methods are not required.

The process of the invention provides for the first time a commercially feasible method for extracting potentially film-forming materials from agricultural waste in a manner which opens up the possibility of using films, fibres or shaped articles formed from such materials in the packaging of food products, even from the very same food products from which the agricultural waste in recovered.

The solid purified product may comprise a polysaccharide. The polysaccharide may comprise starch, cellulose or polylactic acid (PLA). Cellulose is preferred in some embodiments. Thus, the alkaline polysaccharide-containing precursor material may be an alkaline cellulose-containing precursor material.

The process of the present invention removes hemicellulose and lignin from the alkaline polysaccharide-containing precursor material. This can result in a solid purified product comprising cellulose and hemicelluloses including xylan, xyloglucan, glucomannan and callose.

Cellulose films are already known in the art for use in packaging as an alternative to plastic films. The method of the present invention may therefore be used to provide an alternative source of solid purified cellulose material for use in such films, which is cheaper and more environmentally friendly. Additionally, the cellulose material resulting from the present invention is more stable than the cellulose materials known in the art.

The acid may comprise a weak acid, which may be a carboxylic acid, such as acetic acid. The concentration of acid may be about 1 to about 20% w/w.

The acid is used to neutralise the alkaline polysaccharide-containing material. This can involve neutralising both the solid and the liquid in the material. The resulting pH of the neutralised solid polysaccharide-containing material may be between 6 and 8, preferably around 7.

Neutralisation can be achieved by identifying the amount of hydroxide used to produce the alkaline polysaccharide-containing precursor and then adding an excess of acid to ensure full neutralisation (i.e. to ensure that there are no alkaline groups left on the material). The acid then can be washed out of the material. Thus, both the amount and the concentration of acid used is dependent on the amount of hydroxide used.

The acid may be added to a solid alkaline polysaccharide-containing material to create a neutralised solid polysaccharide-containing material. The acid may be added to an alkaline solution including the polysaccharide-containing material. In this embodiment, the neutralised solid polysaccharide-containing material is obtained from the neutralised solution by any conventional means known in the art such as filtration, optionally using a Buchner funnel, a vacuum and/or a centrifuge.

The inventors have found that the use of an acid to neutralise the alkaline polysaccharide-containing material helps to increase the solubility of the solid material, in particular when subsequently mixed with bleach. This is different to conventional methods wherein acid is used to create an acidic solution.

The polysaccharide-containing material may be left in the acid for between about 10 minutes and about 3 hours, preferably between about 0.5 and about 1 hours. This can ensure that all of the solid material has been neutralised.

The bleach may be neat. The term “neat” is to be construed to mean that the bleach contains no other components, for example the bleach has not been diluted and is without solvent.

The bleach may comprise a chlorine containing bleach. For example, the bleach may comprise sodium hypochlorite.

The bleach may comprise non-chlorine containing bleach. For example, the bleach may comprise hydrogen peroxide.

The bleach may be at a concentration of between 0.1 and 10% w/w, preferably between 0.1 and 2% w/w.

The mixture of neutralised solid polysaccharide-containing material and bleach may be stirred. The mixture may be stirred for a time in the range from about 0.5 to about 20 hours, preferably from about 1 to about 20 hours, from about 1 to about 10 hours or from about 10 to about 20 hours. This can ensure that all of the solids react with the bleach and it is believed that the increased exposure to oxygen increases the reactivity and ultimate solubility of the product. Treatment with bleach for this amount of time results in swelling of the solid polysaccharide-containing material.

More than one bleaching step may be included in the method of the invention. The solid product may be washed with water between each bleaching step. The number of bleaching steps may depend on the type of polysaccharide-containing precursor material used, as well as the conditions of the earlier steps of the method.

One or more steps of the method according to the invention may be carried out at a temperature between about 2 and about 90° C. and preferably between about 2 and about 60° C. One or more steps of the method according to the invention may be carried out at a temperature between about 2 and about 50° C. Thus, the bleaching step may occur at said temperatures.

Lignin may crosslink to cellulose at temperatures greater than about 90° C. The presence of crosslinking increases the difficulty of separating lignin from cellulose, and subsequently makes the removal of lignin more difficult. It is therefore preferable to operate the method of the present invention at temperatures below about 90° C.

The inventors of the present invention have unexpectedly found that the use of bleach according to the invention at this temperature removes lignin. The lignin is accessible in the method according to the invention due to the lower temperatures used compared to conventional methods. This makes the extraction of the purified product simpler and more efficient than conventional methods.

Thus, the treatment with bleach for the times mentioned above and at the temperatures mentioned above ensures that most, if not all, of the lignin has been removed.

Without wishing to be bound by theory, it is thought that exposing the cellulose-containing material at temperatures of above 90° C. can cause the lignin in the material to melt onto the cellulose. Thus, the processability of the cellulose is decreased once it has been exposed to temperatures greater than 90° C. Preferably, all of the method steps of the present invention are conducted at temperatures of below 90° C.

However, an increased temperature (i.e. above 20° C.) at some or all of the steps of the process may result in a cleaner pulp. Preferably, a temperature of above 20° C. is used during the washing steps and during the initial alkaline treatment, most preferably a temperature of between 20 and 40° C. This is due to the increased ability to remove surfactants and impurities that are harder to dissolve at reduced temperatures.

Cellulose may also crystallise at increased temperatures which is undesirable. Thus, low temperatures such as those around 2° C. and/or up to around 20° C. in some of the steps can help to prevent the crystallisation of cellulose. Such steps include the neutralisation step and the alkali treatment step.

The temperature used may influence the time of stirring. For example, an increase in temperature may result in a reduced stirring time.

The inventors of the present invention have surprisingly found that the combination of neutralising the alkaline polysaccharide-containing precursor material with an acid and subsequently bleaching the neutralised solid polysaccharide-containing precursor material such that it swells renders the material more soluble than processes in the art. Without wishing to be bound by theory, it is believed that the material only becomes soluble after both of these steps have taken place.

The solid product may be separated from the mixture by filtration, optionally using a Buchner funnel, a vacuum and/or a centrifuge, or any conventional means known in the art.

The process may further comprise one or more steps for creating the alkaline polysaccharide-containing precursor material, which precede the steps for extracting a solid purified product discussed above.

The alkaline polysaccharide-containing precursor material may be created by combining a polysaccharide-containing precursor material with an alkali solution to produce an alkali mixture, stirring the alkali mixture and optionally separating the solid alkaline polysaccharide-containing precursor material from the alkali mixture, preferably by filtration.

The polysaccharide-containing precursor material may be solid. The polysaccharide-containing precursor material may be an agricultural material and may be an agricultural waste, as discussed above.

The agricultural waste may be selected from oat hulls, tomato leaves, rice husks, jute, straw, wheat, miscanthus, hemp, grass, flax or food crop waste. Other suitable agricultural waste sources may include coconut fibre, tea shell, chaff fibres, Phoenix dactylifera, Borassus flabellifer leaf stalks or ginger.

The temperature for this step may be the same as that for the bleaching step. The temperature for this step may be different to that for the bleaching step, but within one or more of the ranges discussed above. The alkali solution may be mixed at a temperature between about 2 and about 90° C., preferably between about 20 and about 60° C., more preferably between about 30 and about 50° C. for the reasons discussed above. This can improve the removal of lignin and the production of cleaner purified product.

Low temperatures such as those between about 2 and about 20° C. can help to prevent crystallisation of cellulose. Methods in accordance with the present invention do not require high process temperatures unlike conventional methods of the art, and so the reaction provides a more cost-effective and less intensive process.

Factors such as stirring time may be changed in accordance with temperature used.

The temperature used may be dependent on the agricultural waste. An increase in temperature may result in a cleaner purified product. The increase temperature aids in the removal surfactants and impurities from the agricultural waste. Thus, a temperature of above about 20° C. may also be beneficial, as discussed above.

The alkali solution may comprise a hydroxide. The alkali solution may be sodium hydroxide.

The hydroxide may be present in a concentration of about 1 to about 30% w/w or about 5 to about 25% w/w by weight of the alkali solution. The hydroxide may be present in a concentration of about 2 to about 22% w/w or about 10 to about 20% w/w by weight of the alkali solution. However, low hydroxide concentrations may also be used, such as about 0.1 to about 6% w/w.

Preferably, the sodium hydroxide is present in a concentration of about 18% w/w by weight of the alkali solution.

The alkali mixture may be stirred. The mixture may be stirred for a time in the range from about 0.5 to about 20 hours, preferably from about 10 to about 20 hours. This can ensure that all of the solids react with the alkali mixture.

The length of time of stirring may be dependent on the temperature used. By way of non-limiting examples, a mixture at 2° C. may be stirred for 16 hours, while a mixture at 50° C. may be mixed for 1 hour.

The polysaccharide-containing precursor material may also be treated with a peroxide. The peroxide may be at low concentrations, namely from about 0.05 to about 10% w/w in solution, preferably from about 0.05 to about 6% w/w in solution. The peroxide solution may be added with the alkali solution or may be used in a separate treatment step before or after treatment with the alkali solution. The separate treatment step can last up to 12 hours.

The amount of stirring may depend on the composition of the agricultural waste. The mixture may be stirred continuously.

The mixing of agriculture waste with sodium hydroxide starts to remove lignin, hemicellulose and any other contaminants present in the agricultural waste. The times and temperatures discussed above ensure that all of the polysaccharide-containing precursor material becomes alkaline polysaccharide-containing precursor material, as required in the later steps of the method.

The solid alkaline polysaccharide-containing precursor material may be separated from the mixture by filtration, optionally using a Buchner funnel, a vacuum and/or a centrifuge, or any other conventional means in the art.

Sodium hydroxide may be recovered with the use of a centrifuge.

The polysaccharide-containing precursor material may be pre-treated. By way of non-limiting examples, the agricultural waste may be pre-treated by drying, shredding, cutting, macerating, washing and/or with the addition of enzymes and/or ion exchange resins. This can help to clean the polysaccharide-containing precursor material, particularly if it comprises agricultural waste. Such treatment steps can also help to make the polysaccharide such as cellulose more accessible and therefore easier to extract. This can improve the efficiency of the method of the invention.

The method may further comprise the step of washing the polysaccharide-containing precursor material, the solid alkaline polysaccharide-containing precursor material, the neutralised solid polysaccharide-containing precursor material and/or the solid purified product. Said washing may comprise washing with water.

The polysaccharide-containing precursor material may be washed during the pre-treatment. Washing during pre-treatment helps to modify the viscosity of the material, which in turn increases processability. Washing can occur at temperatures between about 20 and about 50° C. and for about 0.5 to about 3 hours.

A washing step may precede the step of combining the polysaccharide-containing precursor material with an alkali solution. This may be construed as a “pre-washing” step. The polysaccharide-containing precursor material may be pre-washed with enough water to reduce the sodium hydroxide consumption at the following stage.

The inventors have surprisingly found several advantages are provided with the addition of a pre-washing step. The inclusion of a pre-washing step has been found to help reduce the volume of sodium hydroxide required and to remove unwanted hemicellulose in the subsequent alkali stream. The reduction in sodium hydroxide consumed and removal of hemicellulose is beneficial, both in terms of cost of the process and processability of the resulting material, as well as making the process more environmentally friendly. Any hemicellulose in the subsequent alkali stream can be recovered and included in other processes.

Without wishing to be bound by theory, it is believed the pre-washing step helps to separate and clean the fibres present in the agricultural waste and removes a component that may stabilise particulates. Subsequent film, fibre or shaped article production may also be improved by the removal of stabilised particulates, as the presence of such particulates appears to detrimentally affect film, fibre or shaped article production.

Washing may be carried out at any stage in the process where there is a solid material. For example, washing may be carried out after separation of the solid alkaline polysaccharide-containing precursor material from the alkali mixture. Washing may be carried out prior to neutralising the alkaline polysaccharide-containing precursor material with an acid.

Washing may be carried out after neutralising the alkaline polysaccharide-containing material with acid. Washing may be carried out until the neutralised solid polysaccharide-containing material is clean and no acid is detected. The presence of alkali may be detected with a phenolphthalein indicator. The presence of acid in the material may make the bleaching step less efficient and so preferably, all of the acid is removed.

Washing may be carried out after the neutralised solid polysaccharide-containing material has been mixed with bleach and separated. Washing may be carried out until the solids are bleach free and the smell of bleach has gone. The presence of bleach may be detrimental to the later uses of the solid purified product and so preferably, all of the bleach is removed.

The washing step may comprise hot and/or cold water washes. The washing step may comprise cycles of hot and cold washes. Hot water is water above 20° C. while cold water is water below 20° C. The washing step may comprise washing with hot water, followed by cold water. The washing step may be repeated at least 2 times or at least 3 times. The washing step may be repeated at least 4 times. The number of cycles may be dependent on the step at which the material is washed, the conditions used in the process and/or the polysaccharide-containing precursor material used.

According to a second aspect, there is provided a solid purified product produced by the method described herein.

The solid purified product may undergo further processing and/or be analysed, for example, for solid content.

Solid content can be measured using gravimetric analysis. This can involve drying a known amount (W1) of the product on a plate in an oven, before contacting it with hydrochloric acid. The resulting solid can be removed and washed with water, before being heated and dried again, and subsequently weighed (W2). The solid content is calculated as (W2÷W1)×100.

According to a third aspect, there is provided a process for creating a stable polysaccharide solution comprising the step of dissolving the solid purified product obtained using the method of the invention in a hydroxide solution. The hydroxide may be aqueous sodium hydroxide. The solid purified product may comprise cellulose and so the stable polysaccharide solution may be a stable cellulose solution.

The term “stable” is to be construed to mean the solution will not form a gel at room temperature for an extended period of time. The extended period of time may be more than one week, more than two weeks and preferably, more than a month.

The solid purified product may be directly dissolved in the hydroxide. The dissolution of the solid purified product using known methods surprisingly results in a stable cellulose solution. While the viscosity of the solution increases with increased temperature, any increase in viscosity is reversible when the temperature is lowered, unlike in the prior art where any increase in viscosity is irreversible.

The hydroxide may be at a temperature between about −20 to about 20° C., preferably between about 2 and about 15° C. These low temperatures can help to prevent the crystallisation of the polysaccharide, particularly when the polysaccharide is cellulose. These temperatures can also aid the swelling of the cellulose and therefore can improve the dissolution of the cellulose material in sodium hydroxide.

The solid purified product may be mixed with the hydroxide for between about 1 and about 20 hours, preferably between about 10 and about 20 hours, and/or until the solid purified product has mostly or completely dissolved.

Any undissolved material can then be separated to produce a stable polysaccharide solution, optionally by filtration. Any undissolved material be used as a solid alkaline polysaccharide-containing precursor material in the method discussed above.

The aqueous sodium hydroxide may be present in a concentration of about 2 to about 22% w/w by weight of alkali solution.

The concentration of sodium hydroxide will depend on the solid content of the solid purified product. The concentration of sodium hydroxide may be diluted based on the solid content of the solid purified product.

The concentration of sodium hydroxide in the stable solution may be about 1 to about 10% w/w, preferably about 3 to about 8% w/w. Preferably, the concentration of sodium hydroxide in the stable solution is about 5 to about 7% w/w. Preferably, the concentration of sodium hydroxide in the stable solution is greater than 3% w/w and/or less than about 10% w/w. More preferably, the concentration of sodium hydroxide in the stable solution is about 6% w/w.

The concentration of polysaccharide such as cellulose that is present in the stable polysaccharide solution may be dependent on the source of agriwaste. The concentration of cellulose in the stable cellulose solution may range from about 1 to about 10%. The inventors of the present invention have found a cellulose concentration of about 1 to 20%, preferably 6 to 12% provides suitable viscosity to allow the liquid to be pumped in industrial processes.

The inventors of the present invention have unexpectedly found that polysaccharide solutions, and particularly cellulose solutions, formed in accordance with the present invention can be stored at room temperature without the occurrence of gelling, unlike solutions from wood pulp that are conventionally dissolved in sodium hydroxide or viscose. Thus, polysaccharide solutions formed according to the present invention have increased gel stability over solutions formed from conventional methods.

According to a fourth aspect, there is provided a stable polysaccharide solution derived from the process described herein. The stable polysaccharide solution may be a stable cellulose solution.

The invention also provides the use of the purified product in a film, fibre or shaped article. Films, fibres or shaped articles comprising the purified product according to the invention have been found to present several benefits. By way of non-limiting examples, films, fibres or shaped articles made according to the present invention are made with an alternative cost-effective raw material, via a greener process and allow bespoke films, fibres or shaped articles to be made with targeted agricultural waste or purified product content. The films, fibres or shaped articles produced according to the invention may comprise at least some portion of agricultural waste.

Thus, according to a fifth aspect, there is provided a process for making a cellulose film, fibre or shaped article using the stable cellulose solution according to the invention.

The film, fibre or shaped article may be made directly from the stable cellulose solution, for example by casting the solution through a die such as a slit die into a non-solvent to form a film, fibre or shaped article.

Alternatively, the stable cellulose solution may be added to a viscose solution, which is then used to create a cellulose film, fibre or shaped article. It is commonly known in the art to use viscose solutions to create cellulosic films, fibres or shaped articles and the stable cellulose solution of the invention can simply be included into the standard viscose solution before a standard processing method.

The stable solution may be added to the viscose solution such that between 1 and 99%, preferably more than 10% and most preferably between 40 and 60% of the solids in the final film, fibre or shaped article produced from the solution is the solid purified product of the present invention.

According to a sixth aspect, there is provided a process for making a cellulose film, fibre or shaped article comprising the step of using the solid purified product obtained in accordance with the invention as at least part of the feedstock. The feedstock may be a conventional feedstock material used in a conventional process for making cellulosic films, fibres or shaped articles and so the solid purified product is simply included in addition to or as a replacement for the conventional feedstock material. The solid purified product comprises cellulose.

The feedstock may further comprise wood pulp.

The ratio of solid purified product to conventional feedstock material, such as wood pulp, in the feedstock may be about 50:50 or about 30:70. Preferably, the ratio of solid purified product to conventional feedstock material, such as wood pulp, is about 20:80 or about 10:90.

The solid purified product may be used at more than one stage of the process of making a film, fibre or shaped article. The solid purified product may be both included as at least part of the feedstock at the start of the process and injected into a viscose solution as a stable cellulose solution, as discussed above.

According to a seventh aspect, there is provided a cellulose film, fibre or shaped article comprising up to about 5% or up to about 15% by weight of solid purified product in accordance with the present invention. Preferably, the cellulose film, fibre or shaped article comprises up to about 20% or up to about 25% by weight of solid purified product in accordance with the present invention.

The cellulose film, fibre or shaped article may be made using any method according to the present invention.

If the solid purified product of the present invention has been derived from agricultural waste, using it to create a cellulose film, fibre or shaped article can reduce the cost of producing a cellulose film, fibre or shaped article by reducing the cost of the raw materials required.

The inventors of the present invention have advantageously found that the present invention may be used to make bespoke films, fibres or shaped articles with a targeted agricultural waste content. This allows the production of cellulose films, fibres or shaped articles which contain at least some portion of a specific agricultural cellulose. This is beneficial when providing films, fibres or shaped articles that comprise compostable, biodegradable and recycled materials.

According to an eighth aspect, the invention provides the use of the solid purified product obtained in accordance with the present invention for injection into films, fibres or shaped articles.

The injection of small particles of the solid purified product into films, fibres or shaped articles may improve the mechanical properties of the film, fibre or shaped article. The particles may comprise cellulose. The film, fibre or shaped article may be a cellulosic film, fibre or shaped article.

The purified product may be converted to small particulates prior to injection. This may be done by mechanical and/or enzymatic treatment. The small particles may be microparticles or nanoparticle. The small particles may be between 20 nm and 10 microns in size.

This may be done using a process such as the HefCel process, in which the solid purified product is mechanically mixed with enzymes, optionally at an elevated temperature (for example between around 40° C. and 50° C.) for an extended period of time (for example between 30 minutes and 2 hours). The temperature may then be further increased to between around 50° C. and 70° C. and the solution mixed for between 6 and 9 hours. A final increase in temperature, for example to around 90° C., is then used to deactivate the enzyme.

The small particles can then be separated from the solution using any conventional means in the art. The particles may be washed, optionally with hot and cold water. This may be done between 3 and 5 times, or until all of the sugars and enzymes are removed.

The solid content of the purified product may determine the injection rate.

According to a ninth aspect, the invention provides a film, fibre or shaped article comprising small particles of the solid purified product obtained according to the invention.

The particles may comprise cellulose. The purified product may have been converted to small particulates prior to inclusion in the film, fibre or shaped article. The film, fibre or shaped article may be a cellulosic film, fibre or shaped article.

The film, fibre or shaped article of the present invention may be used in food packaging. The food packaging may comprise a food product that contains plant-based matter. The packaging can be tailored to suit the food product that is packaged. For example, the film, fibre or shaped article of the present invention may be made using a polysaccharide-containing precursor material that is derived from the agricultural waste of the plant-based matter in the food product.

According to a tenth aspect, the present invention provides a packaged food product containing plant-based matter wherein the packaging comprises a polysaccharide-based film, fibre or shaped article manufactured at least partly from agricultural waste salvaged from a crop of the plant-based matter or a related crop.

The related crop may comprise a crop from the same domain, kingdom, division, subdivision, class, subclass, superorder, order, suborder, family, subfamily, genus or species as the plant-based matter in the food product. Preferably, the related crop comprises a crop from the same division, subdivision, class, subclass, superorder, order, suborder, family, subfamily, genus or species as the plant-based matter in the food product.

The polysaccharide may be starch, cellulose of polylactic acid. Preferably, the polysaccharide is cellulose.

Particularly preferred is a packaged food product according to the above wherein the related crop comprises a plant from the same species as the plant-based matter in the food product.

The invention also provides a method for forming the packaged food product according to the above comprising harvesting a crop comprising a comestible item and non-comestible agricultural waste selected from hulls, husks shells, leaves, stalks and/or stems, separating the comestible item from the agricultural waste, manufacturing a film, fibre or shaped article at least partly from the agricultural waste and using the manufactured film, fibre or shaped article to package a food product comprising the comestible item.

The method of manufacturing the film, fibre or shaped article may comprise any of the method steps discussed above. The film, fibre or shaped article may be any of the films, fibres or shaped articles discussed above.

Also provided is packaging for such a packaged food product, wherein the packaging comprises a polysaccharide-based film, fibre or shaped article manufactured at least partly from agricultural waste derived from a crop of the plant-based food product or a related crop.

The invention will now be more specifically described with reference to the following non-limiting examples.

### EXAMPLES

### Example 1

1500 ml of 18% NaOH was preheated at 30° C. in a water bath and combined with 150 g of pre-washed tomato leaf waste. The mixture was continuously stirred for around 2 hours. The resulting alkali mixture was filtered under a vacuum using Buchner equipment. The solid tomato leaf residue was washed and cleaned with approximately 5 L of hot water followed by 2 L of cold water. The clean solid alkaline tomato leaf residue was neutralised with around 600 ml of 10% acetic acid and left for around 30 minutes to neutralise. The neutralised solid tomato leaf residue was then washed with cycles of hot and cold water until clean and free of acetic acid. 1500 mL of 2.5% sodium hypochlorite was added to create a mixture that could freely mix continuously. The mixture was continuously stirred for a period of around 12 hours. The resulting mixture was then filtered under a vacuum using Buchner equipment. The purified tomato waste material was washed with a sequence of approximately 5 to 6 hot and cold washes until the purified tomato waste material was bleach free.

18% NaOH was placed in 2° C. water bath and left to reach temperature. The purified tomato waste material was then dissolved in 18% NaOH and stirred at temperature for around 2 hours. The relative volumes were such that a 6% NaOH solution was formed. The mixture was then filtered under a vacuum using Buchner equipment. The resulting stable cellulose solution was collected and tested for solid content using gravimetric analysis, to ensure that cellulose was present in the solution.

The resulting stable cellulose solution had not started to form a gel after a month at room temperature, as determined by visual inspection.

This is in contrast to cellulose solutions in sodium hydroxide discussed in T. Budtova and P. Navard, “Cellulose in NaOH-water based solvents: a review” Cellulose, 2016, 23(1), pp. 5-55, which outlines the problems of gel stability in more detail. FIGS. 13 and 15 of this document show gelling occurring in a matter of minutes, while the addition of additives such as ZnO and/or the use of very low temperatures is disclosed to delay gelling for several days. None of the solutions discussed in this document would therefore be stable after a month at room temperature.

### Example 2

1500 ml of 18% NaOH was preheated at 2° C. in a water bath and combined with 250 g of pre-washed tomato leaf waste. The mixture was continuously stirred for around 16 hours. The resulting alkali mixture was filtered under a vacuum using Buchner equipment. The solid tomato leaf residue was washed and cleaned with approximately 4 L of hot water followed by 2 L of cold water. The clean solid alkaline tomato leaf residue was neutralised with around 500 ml of 10% acetic acid and left for around 30 minutes to neutralise. The neutralised solid tomato leaf residue was then washed with cycles of hot and cold water until clean and free of acetic acid. 1500 mL of 2.5% sodium hypochlorite was added to create a mixture that could freely mix continuously. The mixture was continuously stirred for a period of around 3 hours. The resulting mixture was then filtered under a vacuum using Buchner equipment. The purified tomato waste material was washed with a sequence of approximately 5 to 6 hot and cold washes until the purified tomato waste material was bleach free.

18% NaOH placed in 2° C. water bath and left to reach temperature. The purified tomato waste material was then dissolved in 18% NaOH and stirred at temperature for around 16 hours. The relative volumes were such that a 6% NaOH solution was formed. The mixture was then filtered under a vacuum using Buchner equipment. The resulting stable cellulose solution was collected and tested for solid content using gravimetric analysis, to ensure that cellulose was present in the solution.

The resulting stable cellulose solution had not started to form a gel after a month at room temperature, as determined by visual inspection.

This is in contrast to cellulose solutions in sodium hydroxide discussed in T. Budtova and P. Navard, “Cellulose in NaOH-water based solvents: a review” Cellulose, 2016, 23(1), pp. 5-55, which outlines the problems of gel stability in more detail. FIGS. 13 and 15 of this document show gelling occurring in a matter of minutes, while the addition of additives such as ZnO and/or the use of very low temperatures is disclosed to delay gelling for several days. None of the solutions discussed in this document would therefore be stable after a month at room temperature.

### Example 3

150 g of Bagasse waste was weighed into a 3 L plastic beaker. 1500 ml of water was added to the beaker and mixed at 30° C. for 2 hours. The Bagasse slurry was then filtered using a ceramic Buchner funnel and a pre-cut piece of caustic filter cloth. The partially dried Bagasse waste was then transferred to a Vorework mixer and shred on high speed for 2 minutes. The shred Bagasse was emptied out of the mixer and back into the 3 L plastic beaker.

1500 ml of 18% sodium hydroxide at a temperature of 30° C. was added to the plastic beaker containing the Bagasse. The waste slurry was then mixed at 30° C. for 2 hours. The Bagasse slurry was then filtered using a ceramic Buchner funnel and a pre-cut piece of caustic filter cloth. Alternate washes with hot and cold water were then used to clean the Bagasse.

1000 ml of 10% acetic acid was measured into a 3 L plastic beaker. The cleaned Bagasse waste was then taken out of the ceramic Buchner funnel and placed inside the beaker containing the acetic acid. The entire solution was mixed for a period of 45 minutes at 30° C., thereby neutralising the Bagasse following the treatment with sodium hydroxide.

The acetic acid and Bagasse slurry was then filtered again using the ceramic Buchner funnel and filter cloth. Again, alternate hot and cold washes were used to clean the Bagasse. Phenolphthalein was used to check that the Bagasse waste was neutralised and washed through properly.

Once the Bagasse was cleaned and free from acetic acid, the entire contents of the ceramic funnel were placed inside a 3 L plastic beaker for bleaching. 1000 ml of plant standard bleach (sodium hypochlorite) was measured into the plastic beaker containing the Bagasse and the mixture was continuously stirred for a period of 48 hours at room temperature. The Bagasse bleached material and solution were then filtered using the ceramic Buchner funnel and a filter cloth and then washed through with hot and cold water until there was no bleach present in the Bagasse material.

The remaining Bagasse material was then weighed into a 1 L steel beaker. 500 ml of 6% sodium hydroxide at a temperature of 2° C. was added to the steel beaker containing the Bagasse cellulose. The entire contents of the 1 L steel beaker was then mixed for 2 hours in a 2° C. water bath.

When the mixing had been completed, the entire contents of the steel beaker was then filtered again using the ceramic Buchner funnel and filter cloth. The liquid that had passed through the filter cloth was then collected and tested for its solid content the following method:
1. The sample in a pot and a pipette/spreader were weighed together.
2. Between 1.0 g and 1.5 g of the sample was transferred to a glass plate using the pipette/spreader.
3. The sample, pot and pipette/spreader were returned to the balance and the weight of sample added to the glass plate was measured (W₁).
4. The plate was placed in a 60° C. oven for 10 to 15 minutes.
5. The plate was removed from the oven and placed in a plastic tray containing enough 3.0% hydrochloric acid to cover the sample on the plate. The sample was left in the acid for 20 minutes.
6. The regenerated sample material was removed from the glass plate and washed thoroughly under running tap water for at least 10 minutes.
7. The sample material was washed with distilled water.
8. The sample was transferred to a crucible in a 155° C. oven for at least an hour.
9. The dried sample was removed from the crucible and weighed (W₂).

The solid content was then calculated as (W2÷W1)×100, thereby determining the cellulose concentration of the sodium hydroxide solution containing the dissolved Bagasse. The solid content in the final Bagasse solution was 3.22%.

The resulting stable cellulose solution had not started to form a gel after a month at room temperature, as determined by visual inspection.

This is in contrast to cellulose solutions in sodium hydroxide discussed in T. Budtova and P. Navard, “Cellulose in NaOH-water based solvents: a review” Cellulose, 2016, 23(1), pp. 5-55, which outlines the problems of gel stability in more detail. FIGS. 13 and 15 of this document show gelling occurring in a matter of minutes, while the addition of additives such as ZnO and/or the use of very low temperatures is disclosed to delay gelling for several days. None of the solutions discussed in this document would therefore be stable after a month at room temperature.

### Example 4

Five different agricultural waste materials, namely oat hulls/husks, tomato leaf/stalks, jute, hay and straw were mechanically processed and treated with sodium hydroxide to create five different solid alkaline polysaccharide-containing precursor materials.

The precursor materials from each of the agricultural waste samples were neutralised in a 10% acetic acid solution and left for a period of 45 minutes. Each sample was then filtered and washed with water until none of the acid remained. The samples were subsequently bleached in sodium hypochlorite overnight and then filtered and washed again.

The solid content of each the cleaned materials was tested using the following method:
1. The sample in a pot and a pipette/spreader were weighed together.
2. Between 1.0 g and 1.5 g of the sample was transferred to a glass plate using the pipette/spreader.
3. The sample, pot and pipette/spreader were returned to the balance and the weight of sample added to the glass plate was measured (W₁).
4. The plate was placed in a 60° C. oven for 10 to 15 minutes.
5. The plate was removed from the oven and placed in a plastic tray containing enough 3.0% hydrochloric acid to cover the sample on the plate. The sample was left in the acid for 20 minutes.
6. The regenerated sample material was removed from the glass plate and washed thoroughly under running tap water for at least 10 minutes.
7. The sample material was washed with distilled water.
8. The sample was transferred to a crucible in a 155° C. oven for at least an hour.
9. The dried sample was removed from the crucible and weighed (W₂).

The solid content was then calculated as (W₂÷W₁)×100 and the results are outlined in Table 1 below.

TABLE 1

| Precursor Material | Solid Content |
|---|---|
| Oats | 32.66% |
| Tomato | 12.17% |
| Jute | 12.19% |
| Hay | 7.71% |
| Straw | 10.98% |

Subsequently, the exact amount of water and sodium hydroxide needed for the dissolution was calculated. These results are outlined in Table 2 below.

TABLE 2

| Precursor | Amount of solid | Amount of | Amount of |
|---|---|---|---|
| Material | purified product | 18% NaOH | Demin Water |
| Oats | 85 g | 154 g | 223 g |
| Tomato | 310 g | 210 g | 109 g |
| Jute | 300 g | 203 g | 106 g |
| Hay | 380 g | 29.3 g | 78.7 g |
| Straw | 370 g | 226 g | 81 g |

All the experiments were mixed at high shear in a 2° C. water bath for 2 hours. Prior to mixing, the water and NaOH were mixed together and left to cool down in the water bath before being added to the solid purified product.

Once the solutions had finished mixing, they were filtered twice (through a 25 micron filter cloth and a 125 micron filter cloth) and the passed liquid was kept. The solid content was measured and the results are outlined in Table 3 below.

TABLE 3

| Precursor Material | Solid Content |
|---|---|
| Oats | 1.68% |
| Tomato | 6.00% |
| Jute | 8.12% |
| Hay | 5.35% |
| Straw | 5.96% |

The resulting stable cellulose solution had not started to form a gel after a month at room temperature, as determined by visual inspection.

This is in contrast to cellulose solutions in sodium hydroxide discussed in T. Budtova and P. Navard, “Cellulose in NaOH-water based solvents: a review” Cellulose, 2016, 23(1), pp. 5-55, which outlines the problems of gel stability in more detail. FIGS. 13 and 15 of this document show gelling occurring in a matter of minutes, while the addition of additives such as ZnO and/or the use of very low temperatures is disclosed to delay gelling for several days. None of the solutions discussed in this document would therefore be stable after a month at room temperature.

1. A method for extracting a solid purified product from an alkaline polysaccharide-containing precursor material, comprising the steps of:
(a) neutralising the alkaline polysaccharide-containing precursor material with an acid and obtaining a neutralised solid polysaccharide-containing material;
(b) mixing the neutralised solid polysaccharide-containing material with bleach to create a mixture; and
(c) separating a solid purified product from the mixture.

2. The method according to claim 1, wherein the alkaline polysaccharide-containing precursor material is derived from agricultural waste selected from oat hulls, tomato leaves, rice husks, jute, straw, wheat, miscanthus, hemp, grass, flax or food crop waste.

3. The method according to claim 1, wherein the solid purified product comprises a polysaccharide;
optionally wherein the polysaccharide is cellulose.

4. The method according to claim 1, wherein the acid comprises acetic acid; and/or
wherein the bleach is selected from sodium hypochlorite or hydrogen peroxide.

5. The method according to claim 1, wherein the alkaline polysaccharide-containing precursor material is created by:
combining a polysaccharide-containing precursor material with an alkali solution to produce an alkali mixture;
stirring the alkali mixture; and
optionally separating a solid alkaline polysaccharide-containing precursor material from the alkali mixture.

6. The method according to claim 5, wherein the alkali solution comprises sodium hydroxide, optionally wherein the concentration of sodium hydroxide is about 1 to about 30% w/w, about 5 to about 25% w/w, about 6 to about 22% w/w, or about 10 to about 20% w/w by weight of alkali solution.

7. The method according to claim 5, wherein the alkali solution is at a temperature of between about 2 and about 90° C. and/or wherein the mixture is stirred for between about 10 and about 20 hours.

8. The method according to claim 5, wherein the polysaccharide-containing precursor material is pre-treated.

9. The method according to claim 1, further comprising the step of washing the polysaccharide-containing precursor material, the solid alkaline polysaccharide-containing precursor material, the neutralised solid polysaccharide-containing precursor material and/or the solid purified product with water.

10. The method according to claim 9, wherein the washing step comprises washing with hot water, followed by cold water,
optionally wherein the washing step is repeated at least 2 times, at least 3 times, or at least 4 times.

11. The separated solid purified product of claim 1 comprising the solid polysaccharide-containing material.

12. A process for creating a stable polysaccharide solution comprising the step of dissolving the solid purified product of claim 11 in aqueous sodium hydroxide.

13. The process according to claim 12, wherein the concentration of sodium hydroxide in the stable polysaccharide solution is about 1 to about 10% w/w, about 3 to about 8% w/w, or about 5 to about 7% w/w.

14. A stable polysaccharide solution made by the process of claim 12.

15. A process for making a cellulose film, fibre or shaped article,
wherein the cellulose film, fibre or shaped article is made from the stable polysaccharide solution of claim 14, and
wherein the polysaccharide solution comprises cellulose.

16. The process according to claim 15, wherein the process comprises adding the solution to a viscose solution to form the cellulose film, fibre or shaped article therefrom.

17. A process for making a cellulose film, fibre or shaped article, wherein the cellulose film, fibre or shaped article is made from the solid purified product of claim 11, wherein the solid purified product comprises cellulose from a feedstock.

18. The process according to claim 17, wherein the feedstock further comprises wood pulp;
optionally, wherein the ratio of solid purified product to wood pulp in the feedstock is about 50:50, about 30:70, about 20:80 or about 10:90.

19. A cellulose film, fibre or shaped article comprising up to about 5%, up to about 15%, up to about 20%, or up to about 25% by weight of film, fibre or shaped article of the solid purified product of claim 11, wherein the solid purified product comprises cellulose.

20. The cellulose film, fibre or shaped article of claim 19, wherein the cellulose film, fibre or shaped article is made from a stable polysaccharide solution formed by dissolving the solid purified product in aqueous sodium hydroxide.

21. A method for forming a film, fibre or shaped article comprising the step of injecting the solid purified product of claim 11 into a film, fibre or shaped article.

22. The method according to claim 21, wherein the solid purified product is converted into small particulates prior to injection.

23. A film, fibre or shaped article comprising small particles of the solid purified product of claim 11.

24. A packaged food product comprising a food product and packaging,
wherein the food product is made from a crop comprising plant-based material, and
wherein the packaging comprises a film, fibre or shaped article manufactured at least partly from agricultural waste salvaged from a crop of plant-based matter.

25. The packaged food product according to claim 24, wherein the film, fibre or shaped article is manufactured at least partly from agricultural waste salvaged from a crop from the same domain, kingdom, division, subdivision, class, subclass, superorder, order, suborder, family, subfamily, genus or species as the crop comprising the plant-based material from which the food product is made.

26. The packaged food product of claim 24, wherein the packaging comprises a polysaccharide-based film.

27. A method for forming a packaged food product, comprising the steps of:
harvesting a crop comprising plant-based matter, said crop comprising a comestible item and non-comestible agricultural waste selected from hulls, husks shells, leaves, stalks and/or stems,
separating the comestible item from the agricultural waste salvaged from the crop,
making a film, fibre or shaped article at least partly from the agricultural waste, and
packaging the food product with the film, fibre or shaped article to form the packaged food product.
